(19) United States
(12) Patent Application Publication
(10) Pub. No.: US 2026/0172488 A1
(43) Pub. Date: Jun. 18, 2026

(54) SINGLE PHY FOR ETHERNET MULTI-RATE AND CAMERA ASYMMETRIC LINK

(71) Applicant: Infineon Technologies Americas Corp., El Segundo, CA (US)

(72) Inventors: Seid Alireza RAZAVI MAJOMARD, Belmont, CA (US); Aleksei ZHEREBTSOV, Karlsruhe (DE); Ragnar JONSSON, Aliso Viejo, CA (US)

(73) Assignee: Infineon Technologies Americas Corp., El Segundo, CA (US)

(21) Appl. No.: 19/423,154

(22) Filed: Dec. 17, 2025

Related U.S. Application Data
(60) Provisional application No. 63/735,028, filed on Dec. 17, 2024.

(51) Int. Cl. H04L 69/00

(52) U.S. Cl. CPC H04L 69/03

(57) ABSTRACT

A system and method of processing Automotive Ethernet and High-Speed Ethernet signals. The method includes forming a first data path according to a first transmission protocol and a second data path according to a second transmission protocol. The method includes selecting the first data path to receive a first bitstream compliant with the first transmission protocol at a first data rate. The method includes encoding the first bitstream using a first encoding scheme to produce a first encoded bitstream. The method includes upsampling the first encoded bitstream to produce an upsampled bitstream at a different data rate. The upsampled bitstream aligns with transmission requirements of a Physical Medium Attachment (PMA) device. The method includes forwarding the upsampled bitstream to the PMA device.

### CROSS-REFERENCE TO RELATED APPLICATIONS

This application claims the benefit of U.S. Provisional Application Ser. No. 63/735,028 entitled “Single PHY for Ethernet Multi-rate and Camera Asymmetric Link,” filed Dec. 17, 2024, the disclosure of which is incorporated herein by reference in its entirety.

### TECHNICAL FIELD

The present disclosure relates generally to the field of wired ethernet communications, and more particularly, to systems and methods of processing Automotive Ethernet and High-Speed Ethernet signals at the Physical Layer (PHY).

### BACKGROUND

Modern automotive systems increasingly require seamless integration with high-speed backbone networks for advanced driver assistance systems (ADAS), over-the-air updates, and cloud-based analytics. Conventional solutions often rely on multiple discrete PHY and Physical Coding Sublayer (PCS) devices, which increase cost, complexity, and power consumption. A unified approach simplifies design and enhances scalability. Ethernet technology has become a foundational communication protocol across numerous industries, enabling reliable, high-speed data exchange over various physical media. As networking requirements have grown more complex, multiple standards have emerged to address different performance and environmental needs. These standards define aspects such as data rates, encoding schemes, and physical layer characteristics, ensuring interoperability within their respective domains. However, the diversity of standards often introduces design challenges when systems must support heterogeneous networking environments. Solutions that reduce complexity and improve flexibility in handling multiple Ethernet specifications are increasingly important for modern applications.

### BRIEF DESCRIPTION OF THE DRAWINGS

The present disclosure is illustrated by way of example, and not by way of limitation, in the figures of the accompanying drawings in which like reference numerals refer to similar elements and in which:

FIG. 1 illustrates an example Ethernet Multi-Rate Networking (EMRN) system for processing Automotive Ethernet and High-Speed Ethernet signals, according to some embodiments;

FIG. 2 illustrates an example a multi-mode PCS configured to process multiple Ethernet standards, according to some embodiments;

FIG. 3 illustrates an example Differential Manchester Encoding (DME) mapping and upsampling procedure, according to some embodiments;

FIG. 4 illustrates an example automotive environment in which an Ethernet Multi-Rate IC (EMRIC) Device may be deployed, in accordance with some embodiments; and

FIG. 5 illustrates a flow diagram of processing Automotive Ethernet and High-Speed Ethernet signals, according to some embodiments.

### DETAILED DESCRIPTION

The following description provides specific details such as examples of specific systems, components, methods, to support a clear understanding of various embodiments of the techniques described herein for processing Automotive Ethernet and High-Speed Ethernet signals at the PHY. It will be apparent to those skilled in the art, however, that at least some embodiments may be practiced without these specific details. In other instances, well-known components, elements, or methods are either not described in detail or are illustrated using simplified block diagrams to avoid obscuring the techniques described herein. Accordingly, the specific details presented below are merely exemplary, and particular implementations may differ while still falling within the scope of the present disclosure.

Ethernet technology has evolved to support diverse application domains, including automotive networking and high-speed data center interconnects. Two important standards in this evolution are Institute of Electrical and Electronics Engineers (IEEE) 802.3ch and IEEE 802.3dm. IEEE 802.3ch is an amendment to the IEEE 802.3 Ethernet standard that specifies Physical Layer (PHY) specifications and management parameters for Automotive Ethernet. It supports data rates of 2.5 Gb/s, 5 Gb/s, and 10 Gb/s over a single balanced twisted pair of conductors, designed for in-vehicle networks. This standard enables high-bandwidth, low-latency communication for advanced automotive applications such as cameras, radar, LiDAR, and electronic control units (ECUs). The IEEE 802.3dm Physical Layer (PHY) standard is an amendment to IEEE 802.3 that specifies asymmetrical electrical Automotive Ethernet links, optimized for camera-based end-node connections in vehicles. It supports operation up to 10 Gb/s in one direction (high-speed path) and a lower data rate in the opposite direction (low-speed path), enabling efficient, high-bandwidth communication for automotive applications such as advanced driver-assistance systems (ADAS) and sensor networks. The standard also defines management parameters for these asymmetric links. These capabilities are used for cloud infrastructure, high-performance computing (HPC), and advanced industrial systems.

In a typical Ethernet architecture, a PCS prepares data for transmission by performing encoding and related functions, and communicates with a Physical Medium Attachment (PMA) that handles signal serialization and conditioning before the data reaches the physical medium. On the receive path, these operations are reversed to deliver decoded data to the Media Access Control (MAC) layer.

Conventional PCS devices, typically implemented as integrated circuits (ICs), are designed to support only a single Ethernet PHY standard—not both IEEE 802.3ch and IEEE 802.3dm. This limitation creates significant challenges in environments where heterogeneous Ethernet standards coexist. Automotive systems increasingly involve integration with high-speed backbone networks for ADAS, over-the-air (OTA) updates, and cloud-based analytics.

The inability of conventional PCS devices to support multiple PHY standards forces system designers to deploy separate PCS ICs for each standard, increasing cost, complexity, and board space. This approach also introduces latency and power inefficiencies due to additional interconnects and signal conversions. Furthermore, maintaining multiple PCS implementations complicates system design and reduces scalability, particularly as Ethernet standards continue to evolve. A solution that enables a single PCS device to process signals for multiple PHY standards would significantly simplify system architecture, reduce cost, and improve performance.

Aspects of the present disclosure provide a mechanism for processing both Automotive Ethernet and High-Speed Ethernet signals within a unified architecture. Specifically, the present disclosure introduces an Ethernet Multi-Rate Integrated Circuit (EMRIC) device, implemented on a single semiconductor chip. The EMRIC device incorporates a multi-mode Physical Coding Sublayer (PCS) capable of handling multiple Ethernet standards, such as IEEE 802.3ch and IEEE 802.3dm, without requiring separate PCS implementations. The advantage of this approach is that it enables seamless interoperability between heterogeneous Ethernet domains, reduces the need for multiple discrete components, minimizes board space, and lowers overall system cost. Additionally, by consolidating functionality into a single IC, latency and power consumption are significantly reduced, while scalability and design flexibility are improved for future Ethernet standards.

In an illustrative embodiment, an EMRN system includes a first data path formed according to a first transmission protocol, a second data path formed according to a second transmission protocol, a first multiplexer electrically coupled to inputs of the first data path and the second data path; and a second multiplexer electrically coupled to outputs of the second data path and the second data path. The first multiplexer is configured to route a first bitstream compliant with the first transmission protocol at a first data rate to the first data path. The first data path is configured to encode the first bitstream using a first encoding scheme to produce a first encoded bitstream. The first data path is further configured to upsample the first encoded bitstream to produce an upsampled bitstream at a different data rate. The upsampled bitstream aligns with transmission requirements of a Physical Medium Attachment (PMA) device. The second multiplexer is configured to forward the upsampled bitstream to the PMA device.

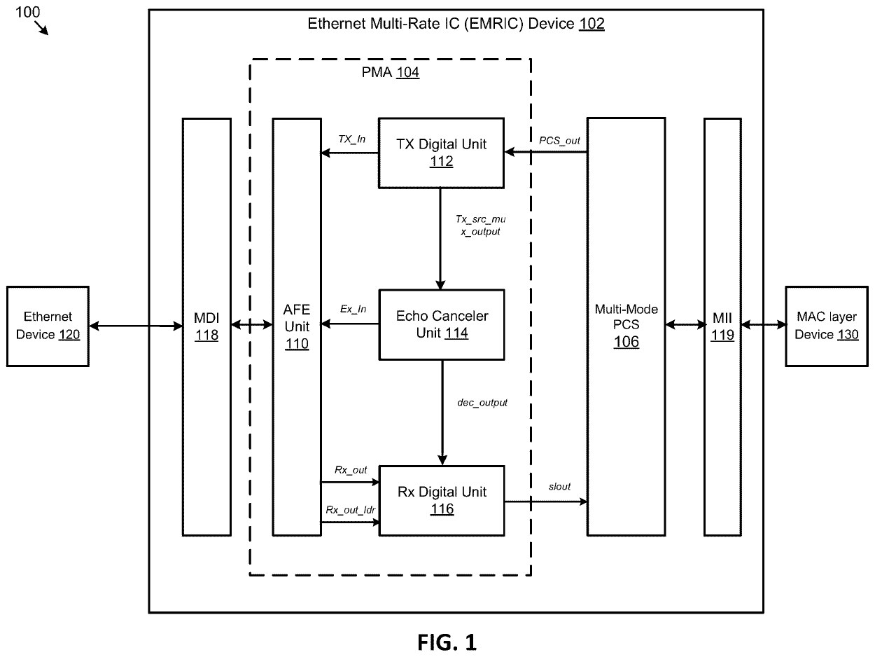

FIG. 1 illustrates an example Ethernet Multi-Rate Networking (EMRN) system for processing Automotive Ethernet and High-Speed Ethernet signals, according to some embodiments. The EMRN system 100 includes an Ethernet Multi-Rate IC (EMRIC) device 102 that is communicatively coupled between an Ethernet device 120 and a MAC layer device 130.

For example, Ethernet devices include automotive components such as cameras, radar units, LiDAR systems, ultrasonic sensors, and electronic control units (ECUs), as well as non-automotive devices such as industrial controllers, network switches, servers, and storage systems.

For example, MAC layer devices include network interface controllers (NICs), Ethernet controllers integrated in system-on-chip (SoC) architectures, automotive gateway processors, and high-performance computing processors.

The EMRIC device 102 includes a PMA 104 that is communicatively coupled to the Ethernet device 120 via a media-dependent interface (MDI) 118. The EMRIC device 102 further includes a multi-mode PCS 106 that is communicatively coupled to the MAC layer device 130 (i.e., an upper layer of the network stack) via a media-independent interface (MII) 119. The PMA 104 is communicatively coupled to the multi-mode PCS 106. Although not shown in FIG. 1, the PMA 104 interfaces with a Physical Medium Dependent (PMD) sublayer, which connects to the physical medium through the MDI 118.

The PMA 104 includes an analog front-end (AFE) unit 110 that is communicatively coupled to a TX digital unit 112, an echo canceler unit 114, and an RX digital unit 116. Both the TX digital unit 112 and the RX digital unit 116 are communicatively coupled to the multi-mode PCS 106. The AFE unit 110 provides analog signal conditioning for transmission and reception, while the TX digital unit 112 and RX digital unit 116 handle digital signal processing tasks associated with transmit and receive paths. The echo canceler unit 114 operates to mitigate interference caused by signal reflections during full-duplex communication.

The multi-mode PCS 106 is configured to encode and decode data (e.g., using 8B/10B encoding) and perform additional functions such as scrambling, insertion/removal of alignment markers, and auto-negotiation to establish link parameters between the EMRIC device 102 and the Ethernet device 120. The multi-mode PCS 106 acts as the highest sublayer of the physical layer, positioned between the PMA 104 and the MII 119.

Unlike conventional PCS devices that are typically designed to support a single Ethernet physical layer specification, the multi-mode PCS 106 is configured to process signals corresponding to multiple Ethernet PHY standards. For example, the multi-mode PCS 106 can process signals compliant with IEEE 802.3ch PHY and IEEE 802.3dm PHY. This multi-mode capability enables the EMRIC device 102 to interface with heterogeneous Ethernet environments without requiring separate PCS devices for each PHY type.

In some embodiments, the multi-mode PCS 106 is further configured to support different variations of the IEEE 802.3dm PHY standard. For example, the multi-mode PCS 106 can process signals compliant with IEEE 802.3dm-ACT, which is an anticipated extension of IEEE 802.3dm that specifies additional capabilities for the ethernet link. Although IEEE 802.3dm-ACT has not yet been formally adopted by the IEEE, the EMRIC device 102 is designed to accommodate such future variations to enable compatibility with evolving high-speed Ethernet environments without requiring separate PCS implementations.

In operation, data flows from the upper layers to the multi-mode PCS 106, which applies encoding and other processing before passing the data to the PMA 104. Within the PMA 104, the TX digital unit 112 processes the outgoing data and forwards it to the AFE unit 110 for analog conversion and transmission over the physical medium via the PMD sublayer. Upon reception, the AFE unit 110 converts the incoming analog signal to digital form for the RX digital unit 116, which forwards the data to the multi-mode PCS 106 for decoding and additional processing prior to delivery to the upper layers. The echo canceler unit 114 operates in parallel to reduce signal reflections and improve link quality.

In some embodiments, the EMRIC device 102 is implemented on a single integrated circuit (IC), which refers to a monolithic semiconductor die containing multiple interconnected electronic components forming a functional unit. In other embodiments, the PMA 104 and the Media Dependent Interface (MDI) 118 are implemented on a first IC, while the multi-mode PCS 106 and the Media Independent Interface (MII) 119 are implemented on a second IC.

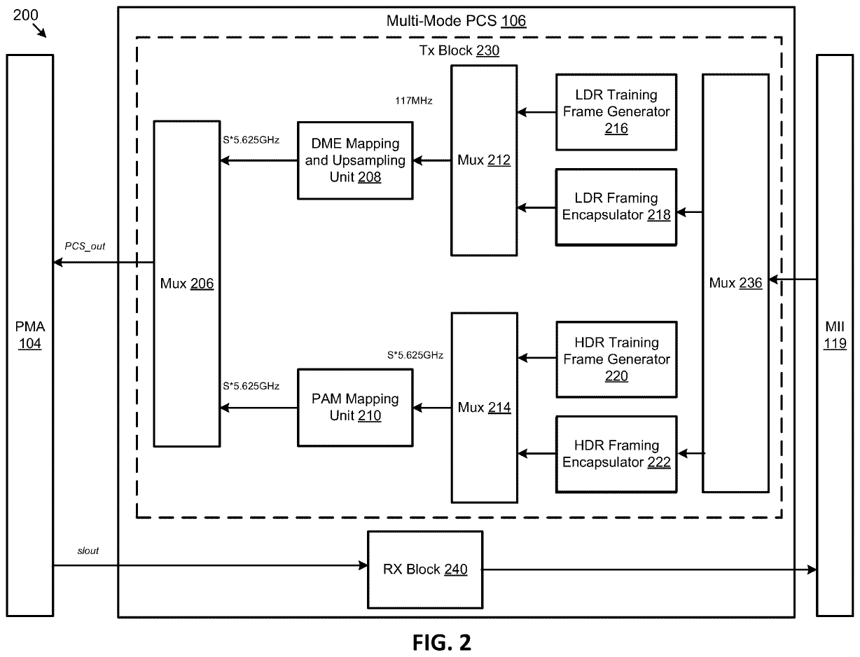

FIG. 2 illustrates an example a multi-mode Physical Coding Sublayer (PCS) configured to process multiple Ethernet standards, according to some embodiments. The multi-mode PCS 106 includes a transmitter (Tx) block 230 for transmitting data to the PMA 104, where the data is either internally generated (during a training frame sequence) or data received from the MII 119. The multi-mode PCS 106 includes a receiver (Rx) block 240 for receiving data from the PMA 104, and passing it to the MII 119.

The Tx block 230 includes an IEEE 802.3dm-compliant path, consisting of a Low Data Rate (LDR) training generator 216, an LDR framing encapsulator 218, a multiplexer 212, and a DME mapping and upsampling unit 208 for processing IEEE 802.3dm-compliant signals.

The multi-mode PCS 106 includes a multiplexer 236 that selects the incoming bitstream from the MII 119 and routes it to either the LDR framing encapsulator 218 or the HDR framing encapsulator 222. In some embodiments, selecting the IEEE 802.3dm-compliant path powers down the IEEE 802.3ch-compliant path. Conversely, selecting the IEEE 802.3ch-compliant path powers down the IEEE 802.3dm-compliant path.

The multi-mode PCS 106 includes a multiplexer 206 for selecting to receive bitstreams from the IEEE 802.3dm-compliant path or the IEEE 802.3ch-compliant path, and providing the selected bitstream to the PMA 104.

The LDR training generator 216 is configured to generate an IEEE 802.3dm-compliant bitstream in an internal testing mode and provide the bitstream to the multiplexer 212. The LDR framing encapsulator 218 is configured to receive an IEEE 802.3dm-compliant bitstream from the MAC layer device 130 via the MII 119, encapsulate the bitstream, and provide the encapsulated bitstream to the multiplexer 212.

The multiplexer 212 selects either the bitstream from the LDR training generator 216 or the bitstream from the LDR framing encapsulator 218 and forwards the selected bitstream to the DME mapping and upsampling unit 208.

The DME mapping and upsampling unit 208 is configured to perform Differential Manchester Encoding (DME) on the incoming IEEE 802.3dm-compliant bitstream. In DME, each bit is represented by a transition within the symbol period, which provides inherent clock recovery and robustness against noise, which is ideal for automotive environments.

In some embodiments, the DME mapping and upsampling unit 208 receives a bitstream at a symbol rate of approximately 117 megahertz (MHz) and upsamples the bitstream to produce an output waveform at a rate of S×5.625 gigahertz (GHz), where S depends on the rate of the incoming bitstream from the device connected to the Ethernet cable. For example, if the incoming bitstream is 2.5 gigabits per second (Gb/s), then S=½; if the incoming bitstream is 5 Gb/s, then S=1; and if the incoming bitstream is 10 Gb/s, then S=1.

After encoding, the unit performs upsampling to increase the symbol rate so that the encoded signal aligns with the transmission requirements of the PMA 104. Upsampling may involve inserting additional samples per symbol or applying interpolation filters to achieve the target sampling frequency for high-speed serialization. The encoded and upsampled signal is then provided to the multiplexer 206.

Similarly, the HDR training generator 220 is configured to generate an IEEE 802.3ch-compliant bitstream in an internal testing mode and provide the bitstream to the multiplexer 214. The HDR framing encapsulator 222 receives an IEEE 802.3ch-compliant bitstream from the MAC layer device 130 via the MII 119, encapsulates the bitstream, and provides it to the multiplexer 214.

The multiplexer 214 selects either the bitstream from the HDR training generator 220 or the bitstream from the HDR framing encapsulator 222 and forwards the selected bitstream to the PAM mapping unit 210.

The PAM mapping unit 210 is configured to map the incoming IEEE 802.3ch-compliant bitstream into Pulse Amplitude Modulation (PAM) symbols, such as PAM4 or PAM8, depending on the selected mode. PAM encoding allows multiple bits to be represented by a single symbol. The resulting PAM-encoded signal is then provided to the multiplexer 206.

In some embodiments, the PAM mapping unit 210 receives a bitstream at a symbol rate of S×5.625 gigahertz (GHz), where S depends on the rate of the incoming bitstream from the device connected to the Ethernet cable. For example, if the incoming bitstream is 2.5 gigabits per second (Gb/s), then S=¼; if the incoming bitstream is 5 Gb/s, then S=½; and if the incoming bitstream is 10 Gb/s, then S=1.

In some embodiments, the PAM mapping unit 210 may be configured to upsample the bitstream output from multiplexer 214 when the data rates of this bitstream and the bitstream output from multiplexer 212 are not integer multiples of each other. For example, if the DME mapping and upsampling unit 208 receives a first bitstream at 2 Gb/s and the PAM mapping unit 210 receives a second bitstream at 3 Gb/s, the DME unit upsamples the first bitstream by a factor of 3 to produce a 6 Gb/s stream, and the PAM unit upsamples the second bitstream by a factor of 2 to also produce a 6 Gb/s stream. In another example, the first signal may be upsampled by a factor of 1.5 to align disparate rates.

In certain embodiments, the DME mapping and upsampling unit 208 and/or PAM mapping unit 210 may employ more advanced techniques to improve signal quality and flexibility. The up-sampling process can include an anti-aliasing filter, such as a first-order holding filter, prior to the up-sampling stage to reduce spectral artifacts and maintain signal integrity. Furthermore, the mapping functionality may be extended to support a wide range of modulation schemes beyond those currently described. Examples include PAM2, PAM4, PAM16, or even spread-spectrum signaling, enabling compatibility with diverse transmission standards and improving overall system adaptability.

In some embodiments, EMRIC device 102 can be configured to select (via mux 236 and mux 206) either its IEEE 802.3dm-compliant path or its IEEE 802.3ch-compliant path using one of two approaches. In a first approach, EMRIC device 102 may be manually configured by a user or system controller to operate in a specific mode, such as IEEE 802.3ch or IEEE 802.3dm. This configuration can be performed through register settings, software commands, or other control mechanisms. In a second approach, EMRIC device 102 is configured to automatically select the appropriate path based on the outcome of an auto-negotiation process, enabling dynamic adaptation without manual intervention.

Auto-negotiation is a standardized Ethernet procedure that occurs between two link partners at the physical layer to determine the highest common set of capabilities, such as supported data rates and physical layer standards. This process uses signaling defined by IEEE 802.3, such as Fast Link Pulses (FLPs) or equivalent mechanisms, exchanged over the physical medium.

In the configuration shown, EMRIC device 102 performs auto-negotiation with Ethernet device 120 connected through MDI 118. During this process, each device advertises its supported modes, including IEEE 802.3ch and IEEE 802.3dm. Based on the negotiated mode, EMRIC device 102 internally activates the corresponding PCS path: the IEEE 802.3ch-compliant path, which is configured to receive IEEE 802.3ch-compliant signals from the MAC layer device 130 via the MII 119, or the IEEE 802.3dm-compliant path, which is configured to receive IEEE 802.3dm-compliant signals from the MAC layer device 130 via the same interface.

This dynamic path selection enables EMRIC device 102 to adapt seamlessly to heterogeneous Ethernet environments without requiring manual configuration or multiple discrete devices. By leveraging auto-negotiation, the device reduces system complexity, minimizes board space, and supports interoperability between automotive-grade and high-speed backbone networks.

The following examples illustrate embodiments of the EMRIC device 102 (sometimes referred to as a multi-rate communication system).

Example 1 is a method including forming a first data path according to a first transmission protocol and a second data path according to a second transmission protocol; selecting the first data path to receive a first bitstream compliant with the first transmission protocol at a first data rate; encoding the first bitstream using a first encoding scheme to produce a first encoded bitstream; upsampling the first encoded bitstream to a different data rate to produce an upsampled bitstream; and forwarding the upsampled bitstream to a Physical Medium Attachment (PMA) device.

Example 2 is the method of Example 1 including, wherein the first transmission protocol comprises Institute of Electrical and Electronics Engineers (IEEE) 802.3dm or IEEE 802.3dm-ACT, and the second transmission protocol comprises IEEE 802.3ch.

Example 3 is the method of Example 1 including, wherein the first encoding scheme comprises a line coding or modulation scheme selected from Differential Manchester Encoding (DME), Pulse Amplitude Modulation 2 (PAM-2), Pulse Amplitude Modulation 4 (PAM-4), and Pulse Amplitude Modulation 16 (PAM-16).

Example 4 is the method of Example 3 including, wherein the second data path is configured to encode an incoming bitstream using a second encoding scheme selected from the group of PAM-2, PAM-4, and PAM-16.

Example 5 is the method of Example 4 including, wherein PAM- 2 is selected as the first encoding scheme and the second encoding scheme.

Example 6 is the method of Example 1 including, wherein the first encoded bitstream is further processed using a spread spectrum technique.

Example 7 is the method of Example 1 including configuring the second data path to receive a second bitstream compliant with the second transmission protocol at a second data rate; and configuring the second data path to encode the second bitstream using a second encoding scheme to produce a second encoded bitstream; wherein the second data rate and the different data rate correspond to a same data rate.

Example 8 is the method of Example 7 including configuring the first data path to upsample the first encoded bitstream by a first factor and the second encoded bitstream by a second factor to produce encoded bitstreams having a common data rate.

Example 9 is the method of Example 1 including selecting, prior to receiving the first bitstream, the first data path from among the first data path and the second data path.

Example 10 is the method of Example 1 including, wherein the method is implemented by a single integrated circuit device comprising a PMA device and a multi-mode Physical Coding Sublayer (PCS) device.

Example 11 is a multi-rate communication system including a first data path formed according to a first transmission protocol; a second data path formed according to a second transmission protocol; a first multiplexer electrically coupled to inputs of the first data path and the second data path; and a second multiplexer electrically coupled to outputs of the second data path and the second data path; wherein the first multiplexer is configured to route a first bitstream compliant with the first transmission protocol at a first data rate to the first data path; wherein the first data path is configured to encode the first bitstream using a first encoding scheme to produce a first encoded bitstream; and upsample the first encoded bitstream to a different data rate to produce an upsampled bitstream; and wherein the second multiplexer is configured to forward the upsampled bitstream to a Physical Medium Attachment (PMA) device.

Example 12 is the system of Example 11 including, wherein the first transmission protocol comprises Institute of Electrical and Electronics Engineers (IEEE) 802.3dm or IEEE 802.3dm-ACT, and the second transmission protocol comprises IEEE 802.3ch.

Example 13 is the system of Example 11 including, wherein the first encoding scheme comprises a line coding or modulation scheme selected from Differential Manchester Encoding (DME), Pulse Amplitude Modulation 2 (PAM-2), Pulse Amplitude Modulation 4 (PAM-4), and Pulse Amplitude Modulation 16 (PAM-16).

Example 14 is the system of Example 13 including, wherein the second data path is configured to encode an incoming bitstream using a second encoding scheme selected from the group of PAM-2, PAM-4, and PAM-16.

Example 15 is the system of Example 14 including, wherein PAM- 2 is selected as the first encoding scheme and the second encoding scheme.

Example 16 is the system of Example 11 including, wherein the first encoded bitstream is further processed using a spread spectrum technique.

Example 17 is the system of Example 11 including, wherein the second data path is configured to receive a second bitstream compliant with the second transmission protocol at a second data rate; and encode the second bitstream using a second encoding scheme to produce a second encoded bitstream; wherein the second data rate and the different data rate correspond to a same data rate.

Example 18 is the system of Example 17 including, wherein the second multiplexer is configured to select the first data path from among the first data path and the second data path.

Example 19 is the system of Example 11 including, wherein the first data path, the second data path, the first multiplexer, and the second multiplexer are each disposed on a single semiconductor device.

Example 20 is a multi-rate Integrated Circuit (IC) device including a first encoding unit; a second encoding unit; and a multiplexer electrically coupled to the first encoding unit and the second encoding unit; wherein the first encoding unit is configured to receive a first bitstream compliant with a first protocol at a first data rate and a second bitstream compliant with a second protocol at a second data rate; encode the first bitstream using a first encoding scheme to produce a first encoded bitstream; upsample the first encoded bitstream to a third data rate; wherein the second encoding unit is configured to encode the second bitstream using a second encoding scheme to produce a second encoded bitstream; and wherein the multiplexer is configured to select one of the first encoded bitstream or the second encoded bitstream for forwarding to a PMA device.

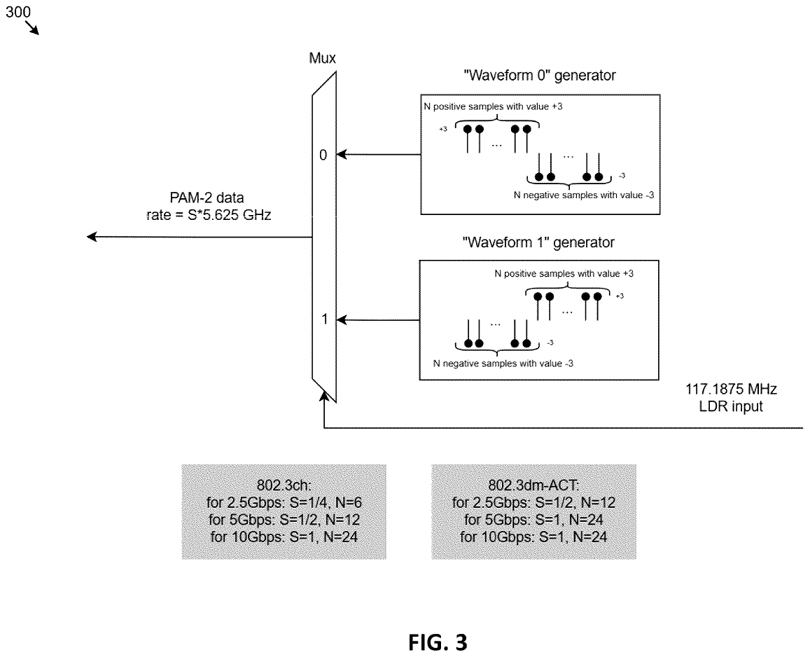

FIG. 3 illustrates an example Differential Manchester Encoding (DME) mapping and upsampling diagram, according to some embodiments. In the diagram 300, the DME mapping and upsampling unit 208 receives an IEEE 802.3dm-compliant bitstream at a low data rate (LDR) input, such as approximately 117.1875 MHz, and processes the bitstream to generate encoded waveforms suitable for high-speed transmission. The unit performs DME encoding by mapping each input bit to a corresponding waveform pattern that includes a transition within the symbol period, thereby providing inherent clock recovery and robustness against noise.

As shown, the DME mapping and upsampling unit 208 includes waveform generators configured to produce sequences of positive and negative samples for each encoded symbol. For example, a “Waveform 0” generator outputs N positive samples with a value of +3 followed by N negative samples with a value of −3, while a “Waveform 1” generator outputs N positive samples with a value of +3 followed by N negative samples with a value of −3, with the transition occurring at a different position to represent a logical “1.” These waveform patterns correspond to Differential Manchester Encoding rules, where logical states are indicated by the presence or absence of mid-symbol transitions.

In some embodiments, Waveform 0 generator corresponds to the LDR training frame generator 216 in FIG. 2. In some embodiments, Waveform 1 generator corresponds to the LDR framing encapsulator 218 in FIG. 2.

The upsampling process increases the effective symbol rate to align with the transmission requirements of the PMA. In some embodiments, the output waveform is generated at a rate of S×5.625 GHz, where S depends on the input data rate. For example, for IEEE 802.3ch operating at 2.5 Gb/s, S=¼ and N=6; for 5 Gb/s, S=½ and N=12; and for 10 Gb/s, S=1 and N=24. Similarly, for IEEE 802.3dm-ACT, S=½ and N=12 for 2.5 Gb/s, and S=1 and N=24 for both 5 Gb/s and 10 Gb/s modes. These parameters ensure that the encoded and upsampled signal meets the timing and spectral requirements for high-speed serialization.

The resulting encoded waveform is provided to a multiplexer (e.g., multiplexer 206 in FIG. 2) for selection and forwarding to the PMA 104. By performing both DME mapping and upsampling within a unified block, the system achieves compatibility with automotive Ethernet standards while supporting scalable data rates for heterogeneous networking environments.

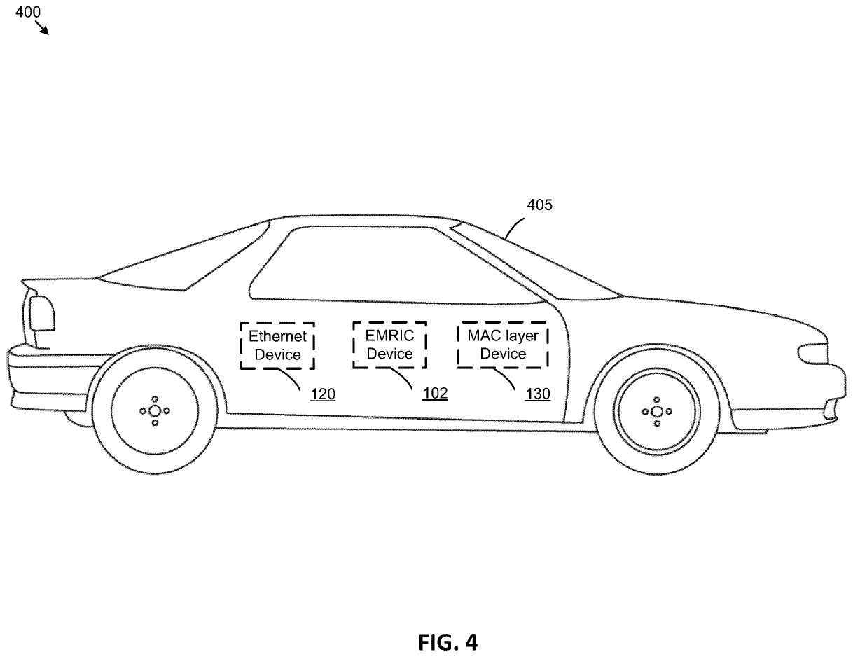

FIG. 4 illustrates an example automotive environment in which an Ethernet Multi-Rate IC (EMRIC) Device may be deployed, in accordance with some embodiments. Environment 400 includes a car 405 that incorporates EMRIC device 102, which may correspond to any EMRIC device discussed herein. The EMRIC device 102 is electrically coupled to one or more ethernet device 120 and MAC layer devices 130.

In some embodiments, the automotive environment may include multiple Ethernet-enabled components such as cameras, radar sensors, and LiDAR units connected to the EMRIC device via twisted-pair cabling. The EMRIC device can dynamically switch between IEEE 802.3ch and IEEE 802.3dm modes to support both in-vehicle and backbone communication requirements.

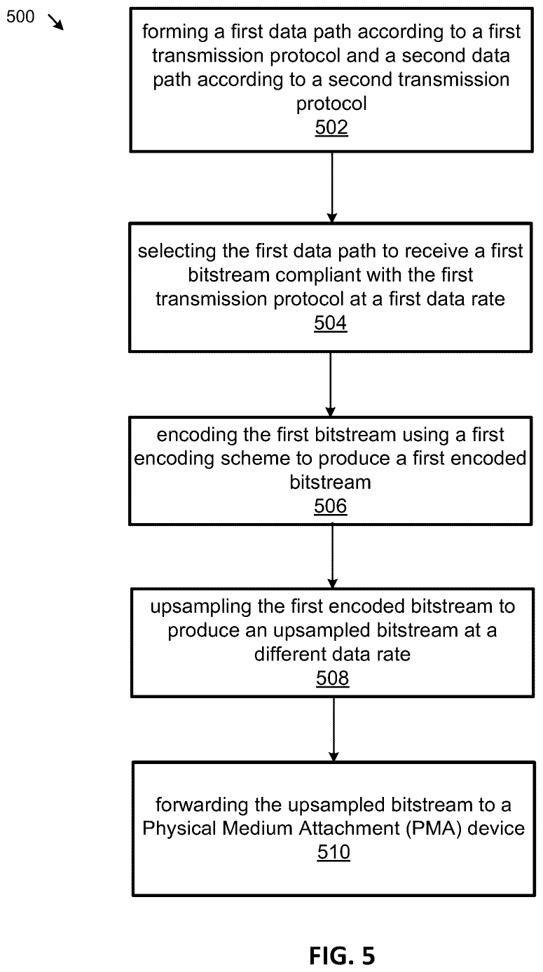

FIG. 5 illustrates a flow diagram of a procedure to process Automotive Ethernet and High-Speed Ethernet signals, according to some embodiments. The one or more operations of procedure 500 may be performed by the EMRIC device 102 in FIG. 1. The procedure 500 begins at operation 502, which includes forming a first data path according to a first transmission protocol and a second data path according to a second transmission protocol.

Operation 504 includes selecting the first data path to receive a first bitstream compliant with the first transmission protocol at a first data rate. In some embodiments, the first transmission protocol may be IEEE 802.3dm or IEEE 802.3dm-ACT.

Operation 506 includes encoding the first bitstream using a first encoding scheme to produce a first encoded bitstream. In some embodiments, the first encoding scheme may be a line coding or modulation scheme selected from Differential Manchester Encoding (DME), Pulse Amplitude Modulation 2 (PAM-2), and Pulse Amplitude Modulation 4 (PAM-4).

Operation 508 includes upsampling the first encoded bitstream to produce an upsampled bitstream at a different data rate.

Operation 510 includes forwarding the upsampled bitstream to a Physical Medium Attachment (PMA) device.

In some embodiments, the procedure 500 may further include optional error detection and correction steps, as well as spread spectrum processing for electromagnetic interference (EMI) mitigation. These enhancements improve link reliability in automotive environments subject to high levels of noise. For example, the EMRIC device 102 may perform error detection and correction on the first bitstream between operations 502 and 504, producing an error-corrected bitstream that is then passed to operation 504.

In the above description, some portions of the detailed description are presented in terms of algorithms and symbolic representations of operations on analog signals and/or digital signals or data bits within a non-transitory storage medium. These algorithmic descriptions and representations are the means used by those skilled in the data processing arts to most effectively convey the substance of their work to others skilled in the art. An algorithm is here and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers, or the like.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the disclosure. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. The embodiments described herein are not intended to limit the scope of the subject matter but rather to enable one skilled in the art to practice, make, and/or use the subject matter.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “calculating,” “determining,” “detecting,” or the like, refer to the actions and processes of an integrated circuit (IC) controller, or similar electronic device, that manipulates and transforms data represented as physical (e.g., electronic) quantities within the controller's registers and memories into other data similarly represented as physical quantities within the controller memories or registers or other such information non-transitory storage medium.

The words “example” or “exemplary” are used herein to mean serving as an example, instance, or illustration. Any aspect or design described herein as “example‘ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an embodiment” or “one embodiment” throughout is not intended to mean the same embodiment or embodiment unless described as such.

Embodiments described herein may also relate to an apparatus (e.g., such as an EMRIC device 102) for performing the operations herein. This apparatus may be specially constructed for the required purposes, or it may include firmware or hardware logic selectively activated or reconfigured by the apparatus. Such firmware may be stored in a non-transitory computer-readable storage medium, such as, but not limited to, read-only memories (ROMs), random access memories (RAMs), EPROMs, EEPROMs, flash memory, or any type of media suitable for storing electronic instructions. The term “computer-readable storage medium” should be taken to include a single medium or multiple media that store one or more sets of instructions. The term “computer-readable medium” shall also be taken to include any medium that is capable of storing, encoding, or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The above description sets forth numerous specific details such as examples of specific systems, components, methods, and so forth, to provide a good understanding of several embodiments of the present disclosure. It is to be understood that the above description is intended to be illustrative and not restrictive. Many other embodiments will be apparent to those of skill in the art upon reading and understanding the above description. The scope of the disclosure should, therefore, be determined with reference to the appended claims, along with the full scope of equivalents to which such claims are entitled.

What is claimed is:

1. A multi-rate Integrated Circuit (IC) device comprising:
a first encoding unit;
a second encoding unit; and
a multiplexer electrically coupled to the first encoding unit and the second encoding unit;
wherein the first encoding unit is configured to:
receive a first bitstream compliant with a first transmission protocol at a first data rate and a second bitstream compliant with a second transmission protocol at a second data rate;
encode the first bitstream using a first encoding scheme to produce a first encoded bitstream;
upsample the first encoded bitstream to a third data rate;
wherein the second encoding unit is configured to:
encode the second bitstream using a second encoding scheme to produce a second encoded bitstream; and
wherein the multiplexer is configured to:
select one of the first encoded bitstream or the second encoded bitstream for forwarding to a PMA device.

2. The multi-rate IC device of claim 1, wherein the first transmission protocol comprises Institute of Electrical and Electronics Engineers (IEEE) 802.3dm or IEEE 802.3dm-ACT, and the second transmission protocol comprises IEEE 802.3ch.

3. The multi-rate IC device of claim 1, wherein the first encoding scheme comprises a line coding or modulation scheme selected from Differential Manchester Encoding (DME), Pulse Amplitude Modulation 2 (PAM-2), Pulse Amplitude Modulation 4 (PAM-4), and Pulse Amplitude Modulation 16 (PAM-16).

4. The multi-rate IC device of claim 3, wherein the second encoding scheme is selected from a group of PAM-2, PAM-4, and PAM-16.

5. The multi-rate IC device of claim 4, wherein PAM-2 is selected as the first encoding scheme and the second encoding scheme.

6. The multi-rate IC device of claim 1, wherein the first encoded bitstream is further processed using a spread spectrum technique.

7. The multi-rate IC device of claim 1, wherein to produce the second encoded bitstream, the second encoding unit is further configured to:
upsample the second encoded bitstream to a fourth data rate matching the third data rate.

8. The multi-rate IC device of claim 1, further comprising:
a media-independent interface; and
a second multiplexer electrically positioned between coupled to the media-independent interface, the first encoding unit and the second encoding unit,
wherein the second multiplexer is configured to:
receive a bitstream from the MII; and
route the bitstream to a first data path of the first encoding unit or a second data path of the second encoding unit.

9. The multi-rate IC device of claim 1, wherein the first encoding unit, the second encoding unit, and the multiplexer are each disposed on a single semiconductor device.

10. A method of multi-rate communications comprising:
forming a first data path according to a first transmission protocol and a second data path according to a second transmission protocol;
selecting the first data path to receive a first bitstream compliant with the first transmission protocol at a first data rate;
encoding the first bitstream using a first encoding scheme to produce a first encoded bitstream;
upsampling the first encoded bitstream to produce an upsampled bitstream at a different data rate, the upsampled bitstream aligns with transmission requirements of a Physical Medium Attachment (PMA) communicatively coupled to an Ethernet device; and
forwarding the upsampled bitstream to the PMA device.

11. The method of claim 10, wherein the first transmission protocol comprises Institute of Electrical and Electronics Engineers (IEEE) 802.3dm or IEEE 802.3dm-ACT, and the second transmission protocol comprises IEEE 802.3ch.

12. The method of claim 10, wherein the first encoding scheme comprises a line coding or modulation scheme selected from Differential Manchester Encoding (DME), Pulse Amplitude Modulation 2 (PAM-2), Pulse Amplitude Modulation 4 (PAM-4), and Pulse Amplitude Modulation 16 (PAM-16).

13. The method of claim 12, wherein the second data path is configured to encode an incoming bitstream using a second encoding scheme selected from a group of PAM-2, PAM-4, and PAM-16.

14. The method of claim 13, wherein PAM-2 is selected as the first encoding scheme and the second encoding scheme.

15. The method of claim 10, wherein the first encoded bitstream is further processed using a spread spectrum technique.

16. The method of claim 10, further comprising:
configuring the second data path to receive a second bitstream compliant with the second transmission protocol at a second data rate; and
configuring the second data path to encode the second bitstream using a second encoding scheme to produce a second encoded bitstream;
wherein the second data rate and the different data rate correspond to a same data rate.

17. The method of claim 16, further comprising:
configuring the first data path to upsample the first encoded bitstream by a first factor and the second encoded bitstream by a second factor to produce encoded bitstreams having a common data rate.

18. The method of claim 10, further comprising:
selecting, prior to receiving the first bitstream, the first data path from among the first data path and the second data path.

19. The method of claim 10, wherein the method is implemented by a single integrated circuit device comprising a PMA device and a multi-mode Physical Coding Sublayer (PCS) device.

20. A multi-rate communication system comprising:
a first data path formed according to a first transmission protocol;
a second data path formed according to a second transmission protocol;
a first multiplexer electrically coupled to inputs of the first data path and the second data path; and
a second multiplexer electrically coupled to outputs of the second data path and the second data path;
wherein the first multiplexer is configured to route a first bitstream compliant with the first transmission protocol at a first data rate to the first data path;
wherein the first data path is configured to:
encode the first bitstream using a first encoding scheme to produce a first encoded bitstream; and
upsample the first encoded bitstream to produce an upsampled bitstream at a different data rate, the upsampled bitstream aligns with transmission requirements of a Physical Medium Attachment (PMA) device communicatively coupled to an Ethernet device; and
wherein the second multiplexer is configured to:
forward the upsampled bitstream to the Physical Medium Attachment (PMA) device.
